(19) United States
(12) Patent Application Publication
(10) Pub. No.: US 2023/0398865 A1
(43) Pub. Date: Dec. 14, 2023

(54) REMOTE DRIVING SYSTEM AND CONTROL METHOD FOR VEHICLE

(71) Applicant: Woven Planet Holdings, Inc., Tokyo (JP)

(72) Inventor: Yuki SUEHIRO, Ichikawa-shi (JP)

(73) Assignee: Woven Planet Holdings, Inc., Tokyo (JP)

(21) Appl. No.: 18/185,442

(22) Filed: Mar. 17, 2023

(30) Foreign Application Priority Data
May 17, 2022 (JP) 2022-081117

(51) Int. Cl. B60K 31/00

(52) U.S. Cl. CPC B60K 31/0058; B60K 31/0066

(57) ABSTRACT

One object of the present disclosure is to provide a technique capable of appropriately suppressing an excessive operation by a remote operator. The present disclosure relates to a remote driving system for controlling a vehicle that is a target of remote driving by the remote operator. The remote driving system executes the following two processes. The first process is a process of determining whether or not an evaluation value, which indicates a degree of likelihood of an excessive operation by the remote operator and is calculated from a shape or a state of a road, is larger than a threshold value. The second process is a process of controlling the vehicle so that a vehicle speed of the vehicle becomes lower than a vehicle speed limit determined based on the evaluation value when the evaluation value is larger than the threshold value.

### CROSS-REFERENCE TO RELATED APPLICATION

The present application claims priority under 35 U.S.C. § 119 to Japanese Patent Application No. 2022-081117, filed May 17, 2022, the contents of which application are incorporated herein by reference in their entirety.

### BACKGROUND

### Field

The present disclosure relates to a technique for controlling a vehicle that is a target of remote driving.

### Background Art

JP2019-012514A discloses a technique relating to a vehicle which is remotely operated by an operator. The vehicle, which is a target of remote operation, includes a communication unit which receives a signal for operating the vehicle including an accelerator input value and a sensor which measures a steering angle and speed of the vehicle. By correcting the accelerator input value, the vehicle suppresses occurrence of sudden acceleration when the vehicle turns right or left.

### SUMMARY

In a remote driving system, information about a vehicle such as an image captured by a camera mounted on the vehicle is transmitted to a remote operator via a communication network, and operational information by the remote operator is transmitted to the vehicle also via the communication network. Since information is transmitted via the communication network, delay is likely to occur, and the vehicle responds to operation by the remote operator belatedly. In addition, it is difficult for the remote operator, who is in a remote place from the vehicle, to physically grasp a state of vehicle control. Therefore, about the vehicle which is a target of the remote driving, an excessive operation by the remote operator is likely to occur.

JP2019-012514A discloses the technique for correcting the accelerator input value under a specific condition of operation such as turning right or left. However, a specific shape or specific state such as a curve or a slope of a road on which the vehicle travels is likely to cause the excessive operation by the remote operator. While the vehicle is traveling on the road which has such a shape or a state, it is required to appropriately suppress the excessive operation without being limited to a situation under a specific operation.

One object of the present disclosure is to provide a technique capable of appropriately suppressing an excessive operation by a remote operator.

A first aspect relates to a remote driving system.

The remote driving system controls a vehicle that is a target of remote driving by a remote operator.

The remote driving system comprises one or more processors.

The one or more processors are configured to execute:
a process of determining whether or not an evaluation value, which indicates a degree of likelihood of an excessive operation by the remote operator and is calculated from a shape or a state of a road, is larger than a threshold value; and
a vehicle speed limiting process of controlling the vehicle so that a vehicle speed of the vehicle becomes lower than a vehicle speed limit determined based on the evaluation value when the evaluation value is larger than the threshold value.

A second aspect relates to a control method for a vehicle.

The control method is a method for controlling a vehicle that is a target of remote driving by a remote operator.

The control method comprises:
determining whether or not an evaluation value, which indicates a degree of likelihood of an excessive operation by the remote operator and is calculated from a shape or a state of a road, is larger than a threshold value; and
controlling the vehicle so that a vehicle speed of the vehicle becomes lower than a vehicle speed limit determined based on the evaluation value when the evaluation value is larger than the threshold value.

According to the aspects of the present disclosure, the excessive operation of the vehicle by the remote operator is appropriately prevented from occurring. As a result, it is possible to improve safety and stability of the vehicle, which is the target of the remote driving.

### BRIEF DESCRIPTION OF THE DRAWINGS

FIG. 1 is a schematic diagram showing a configuration example of a remote driving system according to a present embodiment.

FIG. 2 is a block diagram showing a configuration example of a vehicle according to the present embodiment.

FIG. 3 is a block diagram showing a configuration example of a remote operator terminal according to the present embodiment.

FIG. 4 is a block diagram showing a configuration example of a management server according to the present embodiment.

FIG. 5 is a block diagram showing a first example of a flow of processing executed by the remote driving system according to the present embodiment.

FIG. 6 is a block diagram showing a second example of the flow of processing executed by the remote driving system according to the present embodiment.

FIG. 7 is a graph showing an example of a vehicle speed limiting process according to the present embodiment.

FIG. 8 is a flowchart showing an example of processing based on a policy of functional restriction according to the present embodiment.

FIG. 9 is a schematic diagram showing an example of visual notification to a remote operator in the present embodiment.

FIG. 10 is a schematic diagram showing an example of audible notification to the remote operator in the present embodiment.

### DETAILED DESCRIPTION

Embodiments of the present disclosure will be described with reference to the accompanying drawings.

### 1. Overview

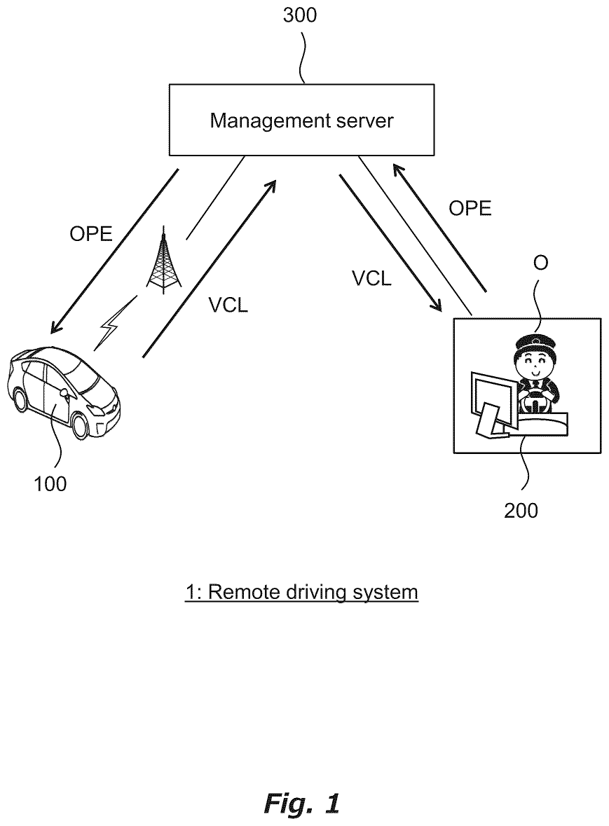

FIG. 1 is a schematic diagram showing a configuration example of a remote driving system 1 according to the present embodiment. The remote driving system 1 includes a vehicle 100, a remote operator terminal 200, and a management server 300. The vehicle 100 is a target of remote driving. The remote operator terminal 200 is a terminal device used by a remote operator O who remotely drives the vehicle 100. The management server 300 manages the remote driving system 1. The management of the remote driving system 1 includes, for example, assigning a remote operator O to a vehicle 100 which needs to be remotely driven. The management server 300 can communicate with the vehicle 100 and the remote operator terminal 200 via a communication network. Typically, the management server 300 is a management server on a cloud. The management server may be configured by a plurality of servers which perform distributed processing.

Various sensors including a camera are mounted on the vehicle 100. The various sensors acquire vehicle information VCL. The vehicle information VCL includes an image which is captured by the camera mounted on the vehicle 100 and indicates a situation around the vehicle 100. The vehicle 100 transmits the vehicle information VCL to the remote operator terminal 200 via the management server 300. That is, the vehicle 100 transmits the vehicle information VCL to the management server 300, and the management server 300 transmits the received vehicle information VCL to the remote operator terminal 200.

The remote operator terminal 200 receives the vehicle information VCL transmitted from the vehicle 100. The remote operator terminal 200 presents the vehicle information VCL to the remote operator O. More specifically, the remote operator terminal 200 includes a display device and displays the vehicle information VCL, which includes the image captured by the camera, on the display device. The remote operator O views the displayed vehicle information VCL to recognizes the situation around the vehicle 100 and performs the remote driving of the vehicle 100. Remote driving information OPE is information related to the remote driving by the remote operator O. For example, the remote driving information OPE includes an amount of operation by the remote operator O. The remote operator terminal 200 transmits the remote driving information OPE to the vehicle 100 via the management server 300. That is, the remote operator terminal 200 transmits the remote driving information OPE to the management server 300, and the management server 300 transmits the received remote driving information OPE to the vehicle 100.

The vehicle 100 receives the remote driving information OPE transmitted from the remote operator terminal 200. The vehicle 100 performs vehicle travel control in accordance with the received remote driving information OPE. In this manner, the remote driving of the vehicle 100 is realized.

In the remote driving system 1, since information is transmitted and received via the communication network as described above, delay is likely to occur in the transmission of information between the vehicle 100 and the remote operator terminal 200. Therefore, a time lag between an actual state of the vehicle 100 and the vehicle information VCL presented to the remote operator O sometimes occurs. Also, if the operation is the same, the vehicle 100 responds to the operation of the remote operator O later than a vehicle which is not a target of the remote driving. In addition, the remote operator O can recognize the vehicle information VCL only as visual information, which is displayed on the display device of the remote operator terminal 200, so it is difficult for the remote operator O to physically grasp, for example, forward, backward, left and right acceleration of the vehicle 100.

As a result, excessive operation by the remote operator O is more likely to occur in the remote driving system 1 than in a control system of a vehicle which is not a target of the remote driving. The excessive operation means that the amount of the operation input into the remote operator terminal 200 by the remote operator O becomes larger than an appropriate amount of operation to control the vehicle 100.

Likelihood of excessive operation by the remote operator O is affected by a shape or a state of a road on which the vehicle 100 travels. For example, while the vehicle 100 is traveling on a curving road, the excessive operation by the remote operator O such as excessively turning the steering wheel or excessively picking up the speed is likely to occur. There is a concern that this kind of excessive operation induces a spin of the vehicle 100. For another example, while the vehicle 100 is traveling downhill, the excessive operation such as the excessively picking up the speed is likely to occur. There is a concern that this kind of excessive operation induces a braking delay. For another example, while a surface of the road on which the vehicle 100 travels is wet because of rain, the excessive operation such as the excessively picking up the speed is likely to occur. There is a concern that this kind of excessive operation induces a slip of the vehicle 100.

In order to prevent the excessive operation which occurs due to the shape or the state of the road, the remote driving system 1 has a policy of functional restriction based on the shape or the state of the road. The remote driving system 1 performs the functional restriction on the vehicle 100 based on the policy.

More specifically, the remote driving system 1 calculates an evaluation value EVA from the shape or the state of the road on which the vehicle 100 travels. The evaluation value EVA is an evaluation value which indicate a degree of the likelihood of the excessive operation by the remote operator O. A threshold value of the evaluation value EVA is determined in advance, and when the evaluation value EVA is larger than the threshold value, the remote driving system 1 performs the functional restriction on the vehicle 100. The evaluation value EVA can be calculated from, for example, a value which indicates curvature of the road, gradient of the road, roughness of the road, a width of a lane, wetness of the road, or the like.

Examples of the functional restriction on vehicle 100 based on the policy include restriction on a steering angle of the steering wheel and restriction on a vehicle speed. Among these examples of the functional restriction based on the policy, the restriction on the vehicle speed is the most suitable. Thus, the remote driving system 1 determines a vehicle speed limit based on the evaluation value EVA, and performs a vehicle speed limiting process, which is a process of controlling the vehicle 100 so that the vehicle speed of the vehicle 100 becomes lower than the vehicle speed limit when the evaluation value EVA is larger than the threshold value.

The excessively picking up the speed occurs more frequently than other excessive operations by the remote operator O, and the excessive operation can be prevented by limiting the vehicle speed in many cases. Therefore, by executing the vehicle speed limiting process as the functional restriction on the vehicle 100, it is possible to properly prevent the excessive operation with respect to various types of shapes or states of the road. As a result, it is possible to enhance safety and stability of the vehicle 100, which is the target of the remote driving. In the following description, it is assumed that the functional restriction on the vehicle 100 based on the policy of the functional restriction is the vehicle speed limiting process.

### 2. Configuration Example of Vehicle

### 2-1. Configuration Example

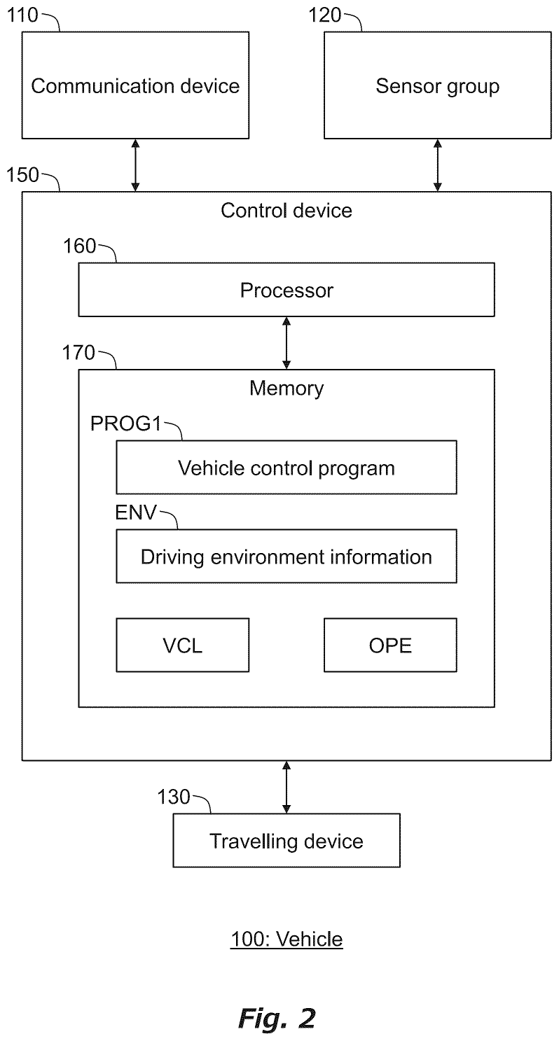

FIG. 2 is a block diagram showing a configuration example of the vehicle 100. The vehicle 100 includes a communication device 110, a sensor group 120, a travelling device 130, and a control device 150.

The communication device 110 communicates with the outside of the vehicle 100. For example, the communication device 110 communicates with the remote operator terminal 200 and the management server 300.

The sensor group 120 includes a recognition sensor, a vehicle state sensor, a position sensor, and the like. The recognition sensor recognizes a situation around the vehicle 100. Examples of the recognition sensor include the camera, a LIDAR (Laser Imaging Detection and Ranging), and a radar. The vehicle state sensor detects a state of the vehicle 100. The vehicle state sensor includes a speed sensor, an acceleration sensor, a yaw rate sensor, a steering angle sensor, or the like. The position sensor detects a position and a direction of the vehicle 100. For example, the position sensor includes a GNSS (Global Navigation Satellite System).

The travelling device 130 includes a steering device, a driving device, and a braking device. The steering device steers wheels. For example, the steering device includes a power steering device. The driving device is a power source which generates a driving force. Examples of the driving device include an engine, an electric motor, and an in-wheel motor. The braking device generates a braking force.

The control device 150 is a computer which controls the vehicle 100. The control device 150 includes one or more processors 160 (hereinafter simply referred to as a processor 160) and one or more memories 170 (hereinafter simply referred to as a memory 170). The processor 160 executes various processes. For example, the processor 160 includes a CPU (Central Processing Unit). The memory 170 stores a variety of information needed for processes by the processor 160. Examples of the memory 170 include a volatile memory, a non-volatile memory, an HDD (Hard Disk Drive), and an SSD (Solid State Drive). The control device 150 may include one or more ECUs (Electronic Control Units).

A vehicle control program PROG1 is a computer program executed by the processor 160. The functions of the control device 150 is realized by the processor 160 executing the vehicle control program PROG1. The vehicle control program PROG1 is stored in the memory 170. Alternatively, the vehicle control program PROG1 may be recorded on a computer-readable recording medium.

### 2-2. Driving Environment Information

The control device 150 acquires driving environment information ENV, which is information indicating a driving environment of the vehicle 100, by using the sensor group 120. The driving environment information ENV is stored in the memory 170.

The driving environment information ENV includes surrounding situation information, which is information indicating a result of recognition by the recognition sensor. For example, the surrounding situation information includes the image captured by the camera. The surrounding situation information may include object information, which is information about an object around the vehicle 100. Examples of the object around vehicle 100 include a pedestrian, another vehicle (a preceding vehicle, a parked vehicle, or the like), a white line, a traffic light, a traffic sign, a roadside structure. The object information indicates a relative position and a relative speed of the object to vehicle 100.

The driving environment information ENV includes vehicle state information, which is information indicating the state of the vehicle 100 detected by the vehicle state sensor.

Furthermore, the driving environment information ENV includes vehicle position information, which is information indicating the position and the direction of the vehicle 100. The vehicle position information is acquired by the position sensor. The control device 150 may acquire highly accurate vehicle position information by performing a well-known localization using map information and the surrounding situation information (the object information).

### 2-3. Vehicle Travel Control

The control device 150 performs the vehicle travel control for controlling traveling of the vehicle 100. The vehicle travel control includes steering control, driving control, and braking control. The control device 150 performs the vehicle travel control by controlling the travelling device 130 (the steering device, the driving device, and the braking device).

### 2-4. Processing Related to Remote Driving

In the following description, it is assumed that the vehicle 100 is remotely driven. The control device 150 communicates with the remote operator terminal 200 via the communication device 110.

The control device 150 transmits the vehicle information VCL to the remote operator terminal 200. The vehicle information VCL is needed for the remote driving by the remote operator O and includes at least a part of the driving environment information ENV described above. For example, the vehicle information VCL includes the surrounding situation information. The vehicle information VCL may further include the vehicle state information or the vehicle position information.

In addition, the control device 150 receives the remote driving information OPE from the remote operator terminal 200. The remote driving information OPE is information related to the remote driving by the remote operator O. For example, the remote driving information OPE includes the amount of the operation of the remote operator terminal 200 by the remote operator O. The control device 150 performs the vehicle travel control in accordance with the received remote driving information OPE.

### 3. Configuration Example of Remote Operator Terminal

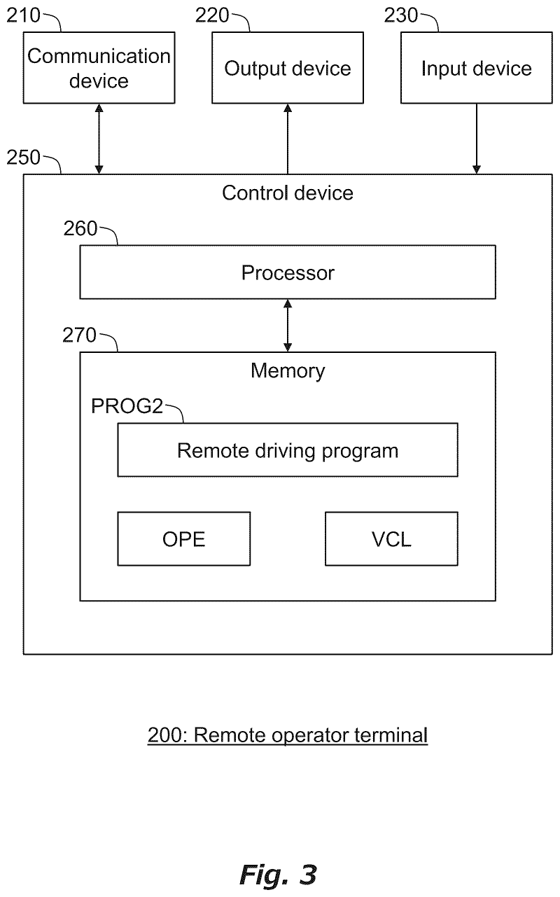

FIG. 3 is a block diagram showing a configuration example of the remote operator terminal 200. The remote operator terminal 200 includes a communication device 210, an output device 220, an input device 230, and a control device 250.

The communication device 210 communicates with the vehicle 100 and the management server 300.

The output device 220 outputs a variety of information. For example, the output device 220 includes the display device. The display device presents a variety of information to the remote operator O by displaying it. For another example, the output device 220 may include a speaker.

The input device 230 receives an input from the remote operator O. For example, the input device 230 includes a remote operation member which the remote operator O operates when remotely driving the vehicle 100. The remote operation member includes a steering wheel, an accelerator pedal, a brake pedal, a direction indicator, or the like.

The control device 250 controls the remote operator terminal 200. The control device 250 includes one or more processors 260 (hereinafter simply referred to as a processor 260) and one or more memories 270 (hereinafter simply referred to as a memory 270). The processor 260 executes various processes. For example, the processor 260 includes a CPU. The memory 270 stores a variety of information needed for processing by the processor 260. Examples of the memory 270 include a volatile memory, a nonvolatile memory, an HDD, an SSD.

A remote driving program PROG2 is a computer program executed by the processor 260. The functions of the control device 250 is realized by the processor 260 executing the remote driving program PROG2. The remote driving program PROG2 is stored in the memory 270. Alternatively, the remote driving program PROG2 may be recorded on a computer-readable recording medium. The remote driving program PROG2 may be provided via a network.

The control device 250 communicates with the vehicle 100 via the communication device 210. The control device 250 receives the vehicle information VCL transmitted from the vehicle 100. The control device 250 presents the vehicle information VCL to the remote operator O by displaying the vehicle information VCL including image information on the display device. The remote operator O can recognize the state or a surrounding situation of the vehicle 100 based on the vehicle information VCL displayed on the display device.

The remote operator O operates the remote operation member of the input device 230.

The amount of the operation of the remote operation member is detected by a sensor set in the remote operation member. The control device 250 generates the remote driving information OPE reflecting the amount of the operation of the remote operation member by the remote operator O. Then, the control device 250 transmits the remote driving information OPE to the vehicle 100 via the communication device 210.

### 4. Configuration Example of Management Server

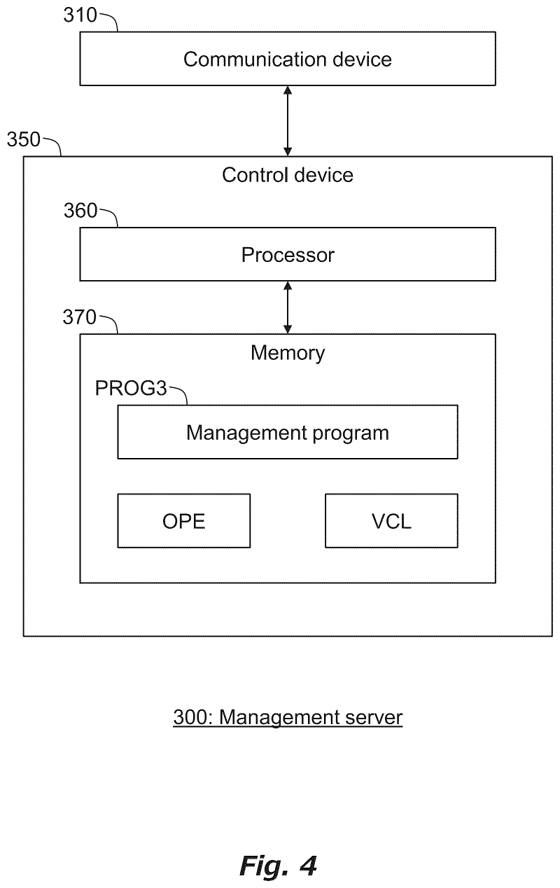

FIG. 4 is a block diagram showing a configuration example of the management server 300. The management server 300 includes a communication device 310 and a control device 350.

The communication device 310 communicates with the vehicle 100 and the remote operator terminal 200.

The control device 350 controls the management server 300. The control device 350 includes one or more processors 360 (hereinafter simply referred to as a processor 360) and one or more memories 370 (hereinafter simply referred to as a memory 370). The processor 360 executes various processes. For example, the processor 360 includes a CPU. The memory 370 a variety of information needed for processing by the processor 360. Examples of the memory 370 include a volatile memory, a nonvolatile memory, an HDD, an SSD.

A management program PROG3 is a computer program executed by the processor 360. The functions of the control device 350 is realized by the processor 360 executing the management program PROG3. The management program PROG3 is stored in the memory 370. Alternatively, the management program PROG3 may be recorded on a computer-readable recording medium. The management program PROG3 may be provided via a network.

The control device 350 communicates with the vehicle 100 and the remote operator terminal 200 via the communication device 310. The control device 350 receives the vehicle information VCL transmitted from the vehicle 100. Then, the control device 350 transmits the received vehicle information VCL to the remote operator terminal 200. In addition, the control device 350 receives the remote driving information OPE transmitted from the remote operator terminal 200. Then, the control device 350 transmits the received remote driving information OPE to the vehicle 100.

### 5. Example of Flow of Processing

### 5-1. First Example

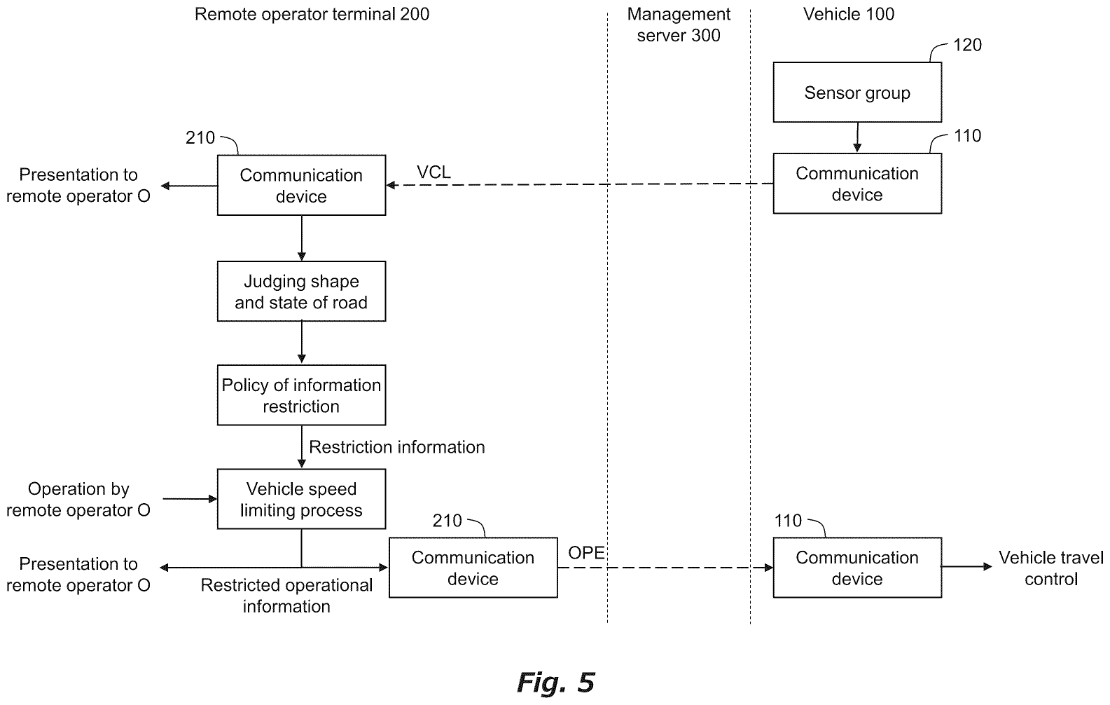

FIG. 5 is a block diagram showing a first example of a flow of processing by the remote driving system 1. In the first example, the remote operator terminal 200 has the policy of the functional restriction and executes the vehicle speed limiting process. In the first example, the vehicle speed limiting process based on the policy of the functional restriction is realized by the processor 260 executing the remote driving program PROG2 stored in the memory 270.

The vehicle 100 acquires the driving environment information ENV including the image captured by the camera by using the sensor group 120. The vehicle information VCL generated from the driving environment information ENV is transmitted to the remote operator terminal 200 via the communication device 110. The remote operator terminal 200 receives the vehicle information VCL via the communication device 210. The remote operator terminal 200 presents the received vehicle information VCL to the remote operator O. At the same time, the remote operator terminal 200 executes a process of judging the shape and the state of the road based on the vehicle information VCL and calculating the evaluation value EVA. This process is realized by the processor 260 executing the remote driving program PROG2 stored in the memory 270.

Restriction information is output based on the evaluation value EVA and a policy of information restriction. The restriction information includes information about the vehicle speed limit. The vehicle speed limiting process is executed based on the output restriction information. In the first example, the vehicle speed limiting process is executed by the processor 260. Operational information input into the remote operator terminal 200 by the remote operator O is converted into restricted operational information by the vehicle speed limiting process.

For example, it is assumed that the remote operator O inputs an amount of acceleration into the remote operator terminal 200 so that the vehicle speed of the vehicle 100 becomes At the same time, it is assumed that the evaluation value EVA is larger than the threshold value and the vehicle speed limit determined based on the evaluation value EVA is At this time, the amount of acceleration included in the restricted operational information is obtained by converting the amount of acceleration input by the remote operator O so that the vehicle speed of the vehicle 100 becomes 50 km/h.

The restricted operational information is transmitted to the vehicle 100 as the remote driving information OPE via the communication device 210. The vehicle 100 receives the remote driving information OPE via the communication device 110 and performs the vehicle travel control in accordance with the received remote driving information OPE. At this time, the restricted operational information may be presented to the remote operator O. In this manner, the vehicle speed limiting process based on the policy of the functional restriction is realized in the first example.

### 5-2. Second Example

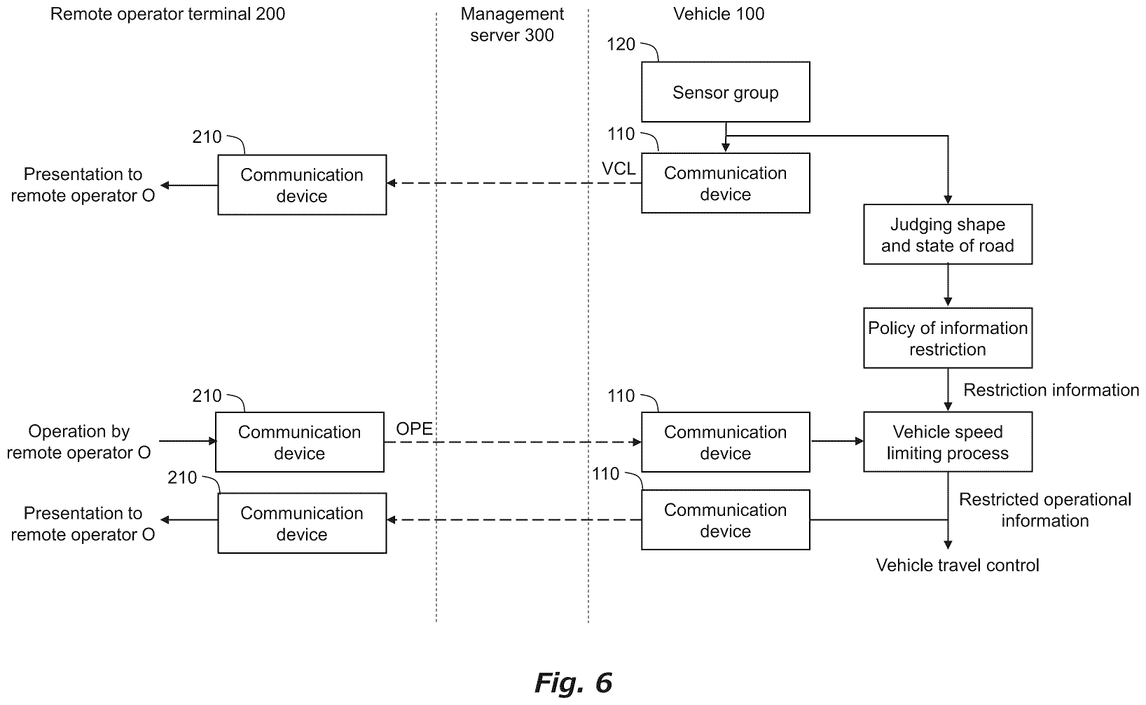

FIG. 6 is a block diagram showing a second example of the flow of processing by the remote driving system 1. In the second example, the vehicle 100 has the policy of the functional restriction and executes the vehicle speed limiting process. In the second example, the vehicle speed limiting process based on the policy of the functional restriction is realized by the processor 160 executing the vehicle control program PROG1 stored in the memory 170.

The vehicle 100 acquires the driving environment information ENV including the image captured by the camera by using the sensor group 120. The vehicle information VCL generated from the driving environment information ENV is transmitted to the remote operator terminal 200 by the communication device 110 via the management server 300. The remote operator terminal 200 receives the vehicle information VCL via the communication device 210 and presents it to the remote operator O.

At the same time, the vehicle 100 executes a process of judging the shape and the state of the road based on the driving environment information ENV and calculating the evaluation value EVA. This process is realized by the processor 160 executing the vehicle control program PROG1 stored in the memory 170. The restriction information is output based on the evaluation value EVA and the policy of the information restriction. The restriction information includes the information about the vehicle speed limit.

The remote operator O performs the remote driving viewing the presented vehicle information VCL. The operational information input into the remote operator terminal 200 by the remote operator O performing the remote driving is transmitted to the vehicle 100 as the remote driving information OPE. The vehicle 100 receives the remote driving information OPE via the communication device 110. The vehicle 100 executes the vehicle speed limiting process based on the received remote driving information OPE and the restriction information. In the second example, the vehicle speed limiting process is executed by the processor 160. The remote driving information OPE is converted into the restricted operational information by the vehicle speed limiting process.

The restricted operational information includes the amount of the operation converted so as to satisfy the vehicle speed limit determined based on the evaluation value EVA. For example, it is assumed that the remote driving information OPE includes the amount of acceleration so that the vehicle speed becomes 70 km/h. At the same time, it is assumed that the evaluation value EVA is larger than the threshold value and the vehicle speed limit determined based on the evaluation value EVA is 50 km/h. At this time, the restricted operational information includes the amount of acceleration obtained by converting the amount of acceleration included in the remote driving information OPE so that the vehicle speed of the vehicle 100 becomes 50 km/h. The vehicle 100 performs the vehicle travel control in accordance with the restricted operational information. At this time, the restricted operational information may be transmitted from the vehicle 100 to the remote operator terminal 200 and presented to the remote operator O. In this manner, the policy of the functional restriction is realized in the second example.

### 6. Specific Example of Evaluation Value

The evaluation value EVA can be calculated from a value which indicates the shape or the state of the road on which the vehicle 100 travels. A specific example of the evaluation value EVA is described below.

### 6-1. First Example of Evaluation Value

In the first example, the curvature of the road is mainly focused on in the shape of the road to calculate the evaluation value EVA. In the following description, an evaluation value which reflects the curvature of the road on which the vehicle 100 travels is referred to as a “first evaluation value”. In the first example, the evaluation value EVA includes the first evaluation value. The first evaluation value is determined so as to become larger as the curvature of the road becomes larger. A first threshold value is determined as the threshold value of the first evaluation value, and when the first evaluation value is larger than the first threshold value, the functional restriction on the vehicle 100 is performed.

The first evaluation value may be a value of the curvature itself, which is a reciprocal of a curvature radius, of the road. For example, the first evaluation value may be the reciprocal of an estimated curvature radius, which is the curvature radius of the road estimated from the driving environment information ENV (for example, a position of the white line) or the like.

For another example, the first evaluation value may be a ratio of the curvature of the road to a standard curvature (that is, a ratio of the standard curvature radius to the curvature radius of the road). For example, the first evaluation value may be a ratio of the standard curvature radius to the estimated curvature radius. The standard curvature radius is a curvature radius with which the vehicle 100 can stably travel. The standard curvature radius depends on the vehicle speed of the vehicle 100. The standard curvature radius is determined in advance for each vehicle speed or each range of the vehicle speed so as to become larger as the vehicle speed becomes higher. Accordingly, the first evaluation value becomes larger as the vehicle speed becomes higher. The vehicle speed limit is determined so that an amount of decrease from a current vehicle speed to the vehicle speed limit becomes larger as the first evaluation value becomes larger.

Here are three examples of how to obtain the estimated curvature radius. In the first example, the estimated curvature radius is estimated based on the position where the vehicle 100 is traveling and information about the curvature of the road obtained from map data. The position where the vehicle 100 is traveling can be acquired by the position sensor. The map data may be stored in the memory 170 of the vehicle 100, or may be stored in the memory 370 of the management server 300. In the second example, a boundary line or a center line of the lane in which the vehicle 100 is traveling is detected from the image captured by the camera, which is included in the sensor group 120, and the curvature radius of the road is estimated based on a curvature radius of the detected line. In the third example, the curvature radius of the road is estimated from the vehicle speed and a yaw rate acquired by the sensor group 120. For example, the ratio of the vehicle speed to the yaw rate is calculated as the curvature radius of the road.

### 6-2. Second Example of Evaluation Value

In the second example, the gradient of the road is mainly focused on in the shape of the road to calculate the evaluation value EVA. In the following description, an evaluation value which reflects the gradient of the road on which the vehicle 100 travels is referred to as a “second evaluation value”. In the second example, the evaluation value EVA includes the second evaluation value. The second evaluation value is determined so as to become larger as the gradient of the road becomes larger. A second threshold value is determined as the threshold value of the second evaluation value, and when the second evaluation value is larger than the second threshold value, the functional restriction on the vehicle 100 is performed.

The second evaluation value may be, for example, an estimated gradient, which is the gradient of the road estimated from the driving environment information ENV or the like.

The estimated gradient is estimated from, for example, a value acquired by an inclination angle sensor included in the sensor group 120.

For another example, the second evaluation value may be a ratio of the gradient of the road (the estimated gradient) to a standard gradient. The standard gradient is a gradient at which the vehicle 100 can stably travel. The standard gradient depends on the vehicle speed of the vehicle 100. The standard gradient is determined in advance for each vehicle speed or each range of the vehicle speed so as to become smaller as the vehicle speed becomes higher. Accordingly, the second evaluation value becomes larger as the vehicle speed becomes higher. The vehicle speed limit is determined so that the amount of decrease from the current vehicle speed to the vehicle speed limit becomes larger as the second evaluation value becomes lager.

### 6-3. Third Example of Evaluation Value

In the third example, a wet road is focused on in the state of the road to calculate the evaluation value EVA. In the following description, an evaluation value which indicates a degree of wetness of the road on which the vehicle 100 travels is referred to as a “third evaluation value”. In the third example, the evaluation value EVA includes the third evaluation value. The third evaluation value is determined so as to become larger as the degree of wetness of the road becomes larger. A third threshold value is determined as the threshold value of the third evaluation value, and when the third evaluation value is larger than the third threshold value, the functional restriction on the vehicle 100 is performed.

The third evaluation value may be, for example, a reciprocal of a friction coefficient of the road. The third evaluation value becomes larger as the degree of wetness of the road becomes larger, that is, as the coefficient of friction of the road becomes smaller.

For another example, the third evaluation value may be a ratio of a standard friction coefficient to the friction coefficient of the road (an estimated friction coefficient). The standard friction coefficient is a friction coefficient with which the vehicle 100 can stably travel. The standard friction coefficient depends on the vehicle speed of the vehicle 100.

The standard friction coefficient is determined in advance for each vehicle speed or each range of the vehicle speed so as to become smaller as the vehicle speed becomes higher. Accordingly, the third evaluation value becomes larger as the vehicle speed becomes higher. The vehicle speed limit is determined so that an amount of decrease from the current vehicle speed to the vehicle speed limit becomes larger as the third evaluation value becomes larger.

The estimated friction coefficient is obtained, for example, by judging the condition of the road based on the mage captured by the camera, which is included in the sensor group 120.

### 7. Vehicle Speed Limit Determined Based on Evaluation Value

In the vehicle speed limiting process, the vehicle speed limit, which is determined based on the evaluation value EVA, may be determined so as to become lower as the evaluation value EVA becomes larger. In this case, an amount of restriction on to the vehicle speed becomes larger as the evaluation value EVA becomes larger.

For example, it is assumed that the evaluation value EVA is the first evaluation value. If the first evaluation value of the road on which the vehicle 100 is traveling is larger than the first evaluation value calculated from the shape of a straight road, it means that the vehicle 100 is traveling on the curving road. Further, if the first evaluation value becomes larger, it means that a curve of the road on which the vehicle 100 travels becomes sharper. Even when the vehicle 100 travels at the same vehicle speed, the spin or falling down of the vehicle 100 occurs more easily as the curve of the road becomes sharper. Therefore, the vehicle speed limit is determined so that the vehicle speed limit becomes lower as the curve of the road becomes sharper, that is, so that the vehicle speed limit becomes lower as the first evaluation value becomes larger. In this manner, it is possible to perform the functional restriction more properly in accordance with the situation.

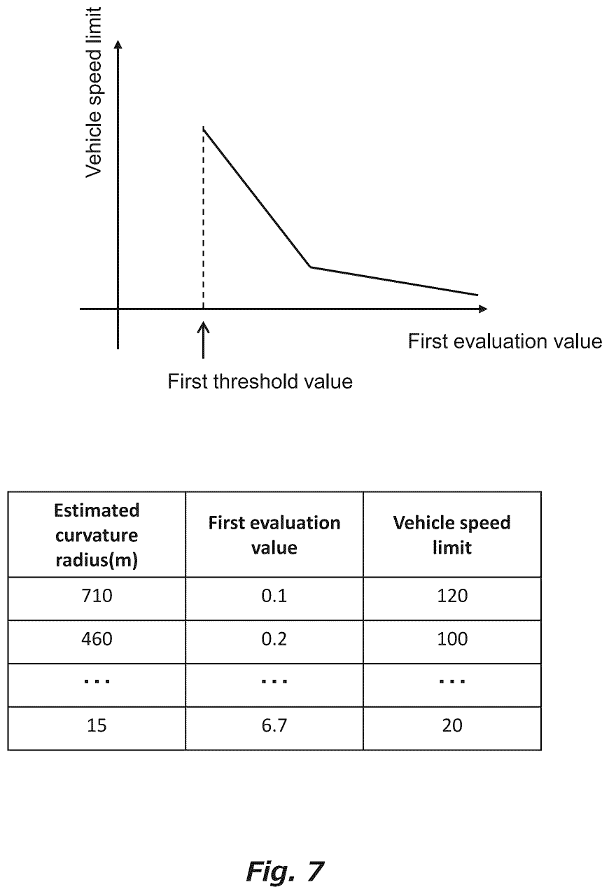

FIG. 7 shows a graph and a table in a case where the evaluation value EVA is the first evaluation value and the vehicle speed limit is determined so as to become lower as the evaluation value EVA becomes larger. In the example shown in FIG. 7, the first evaluation value is the ratio of the standard curvature radius to the estimated curvature radius. The vehicle speed limit may be determined so as to be inversely proportional to the first evaluation value. Alternatively, the vehicle speed limit corresponding to the first evaluation value may be determined by using the exponential function or other function.

If the evaluation value EVA is the second evaluation value or the third evaluation value, the vehicle speed limit can be determined in the same way.

### 8. Flow of Processing

### 8-1. First Example

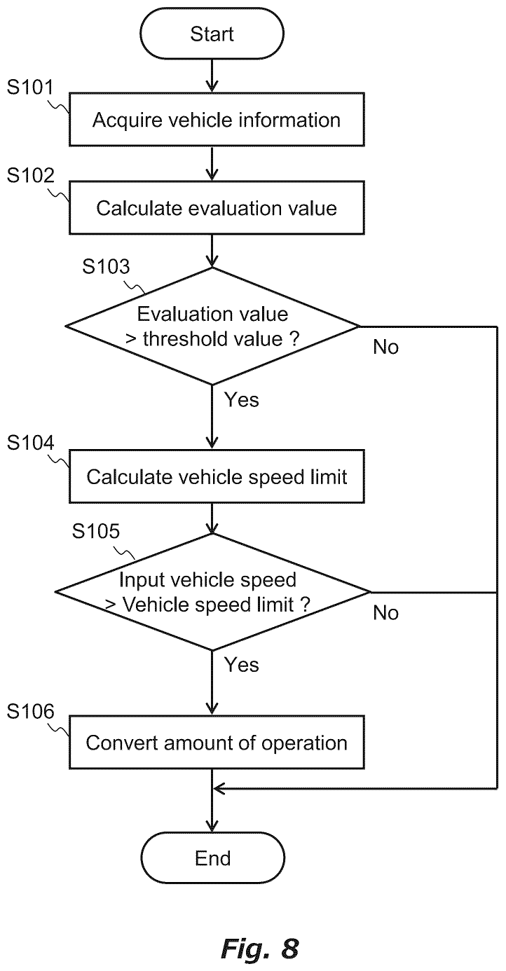

FIG. 8 is a flowchart showing an example of processing for realizing the vehicle speed limiting process based on the policy of the functional restriction. For a first example, a case where the remote operator terminal 200 has the policy of the functional restriction will be described. The flowchart shown in FIG. 8 is executed by the processor 260 at a predetermined control cycle.

In Step S101, the vehicle information VCL is acquired. After the vehicle information VCL is acquired, the processing proceeds to Step S102.

In Step S102, the evaluation value EVA is calculated based on the vehicle information VCL. After the evaluation value EVA is calculated, the processing proceeds to Step S103.

In Step S103, it is determined whether or not the evaluation value EVA is larger than the threshold value. When the evaluation value EVA is larger than the threshold value (Step S103; Yes), the processing proceeds to Step S104. When the evaluation value EVA is equal to or smaller than the threshold value (Step S103; No), the processing ends.

In Step S104, the vehicle speed limit corresponding to the evaluation value EVA is calculated. After that, the processing proceeds to Step S105.

In Step S105, it is determined whether or not the vehicle speed corresponding to the amount of the operation input into the remote operator terminal 200 by the remote operator O is higher than the vehicle speed limit. When the vehicle speed corresponding to the amount of the operation is higher than the vehicle speed limit (Step S105; Yes), the processing proceeds to Step S106. When the vehicle speed corresponding to the amount of the operation is equal to or lower than the vehicle speed limit (Step S105; No), the processing ends.

In Step S106, the amount of the operation input into the remote operator terminal 200 by the remote operator O is converted into the amount of the operation which makes the vehicle speed of the vehicle 100 equal to the vehicle speed limit. After that, the processing ends.

### 8-2. Second Example

For a second example, a case where the vehicle 100 has the policy of the functional restriction will be described. In the second example, the policy of the functional restriction is also realized by processing which can be shown by a similar flowchart to FIG. 8. The processing is executed by the processor 160 at a predetermined control cycle.

In a step corresponding to Step S101 in FIG. 8, the processor 160 acquires the driving environment information ENV. After the driving environment information ENV is acquired, the processing proceeds to Step S102.

In a step corresponding to Step S102, the evaluation value EVA is calculated based on the driving environment information ENV. After the evaluation value EVA is calculated, the processing proceeds to Step S103.

In a step corresponding to Step S103 and Step S104, the same processes as in the first example is executed. After the vehicle speed limit corresponding to the evaluation value EVA is calculated in Step S104, the processing proceeds to Step S105.

In a step corresponding to Step S105, it is determined whether or not the vehicle speed corresponding to the remote driving information OPE is higher than the vehicle speed limit.

When it is higher than the vehicle speed limit (Step S105; Yes), the processing proceeds to Step S106. When it is equal to or lower than the vehicle speed limit (Step S105; No), the processing ends.

In a step corresponding to Step S106, the amount of the operation included in the remote driving information OPE is converted into the amount of the operation that makes the vehicle speed of the vehicle 100 equal to the vehicle speed limit. After that, the processing ends.

### 9. Notification to Remote Operator

While executing the vehicle speed limiting process based on the policy of the functional restriction, the remote driving system 1 may notify the remote operator O of the fact that the vehicle speed limiting process is in execution, the restricted operational information, or the like. The notification is performed by the output device 220 of the remote operator terminal 200. The notification may be performed visually or audibly. By notification, it is possible to restrain the remote operator O from feeling a sense of strangeness and make it easier for the remote operator O to perform the remote driving.

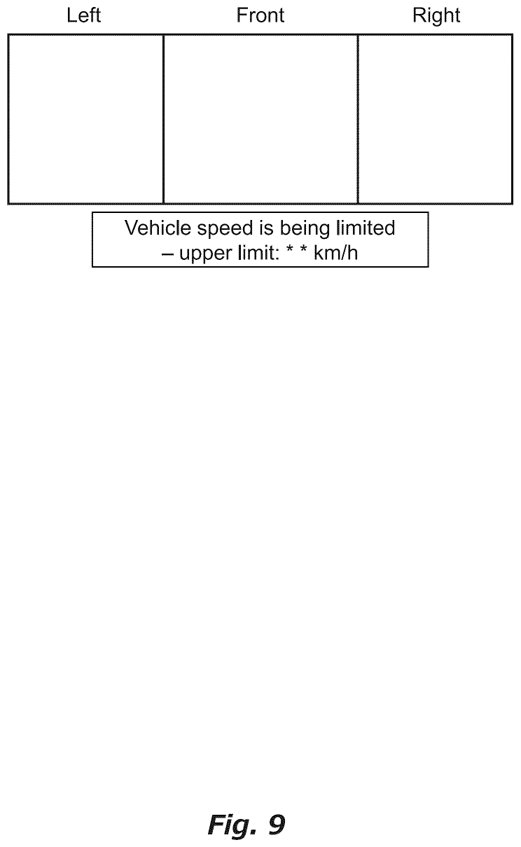

FIG. 9 is a schematic diagram showing an example of visual notification to the remote operator O. In the example shown in FIG. 9, the remote driving system 1 notifies the remote operator O of the fact that the vehicle speed limiting process is in execution by displaying “Vehicle speed is being limited—upper limit: * * km/h” below a monitor screen, which is the display device of the output device 220.

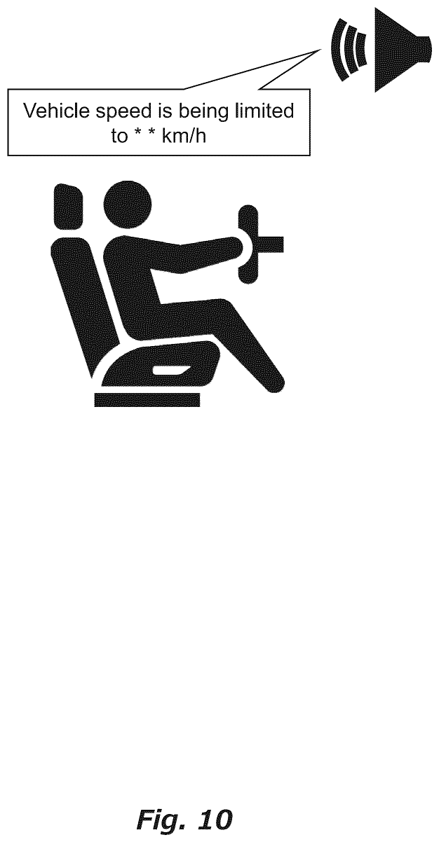

FIG. 10 is a schematic diagram showing an example of audible notification to the remote operator O. In the example shown in FIG. 10, the remote driving system 1 notifies the remote operator O of the fact that the vehicle speed limiting process is in execution by outputting a voice “Vehicle speed is being limited to * *km/h.” from the speaker of the output device 220.

### 10. Vehicle Speed Limiting Process in Case Where Evaluation Value is Equal to or Smaller than Threshold Value

The remote driving system 1 refrains from executing the vehicle speed limiting process when the evaluation value EVA is equal to or smaller than the threshold value. By doing this, the amount of the operation by the remote operator O is restrained only when the road has a specific shape or a specific state. As a result, it is possible to cut down annoying the remote operator O.

### 11. Process of Smoothening Change in Vehicle Speed

In the vehicle speed limiting process executed by the remote driving system 1, a process of smoothening a change in the vehicle speed may be executed when the vehicle speed limiting process starts and/or when the vehicle speed limiting process ends. By doing this, a sudden change in the vehicle speed is suppressed and it is possible to reduce discomforts for a passenger of the vehicle 100 or the remote operator O. Examples of the process of smoothening the change in the vehicle speed includes a process of using a low pass filter.

### 12. Conclusion

As described above, the remote driving system 1 has the policy of the functional restriction for restraining the excessive operation in a situation where the excessive operation of the remote operator O is likely to occur due to the shape or the state of the road. As a result, it is possible to prevent the excessive operation and improve safety and stability of the vehicle 100.

What is claimed is:

1. A remote driving system for controlling a vehicle that is a target of remote driving by a remote operator, the remote driving system comprising one or more processors configured to execute:
a process of determining whether or not an evaluation value, which indicates a degree of likelihood of an excessive operation by the remote operator and is calculated from a shape or a state of a road, is larger than a threshold value; and
a vehicle speed limiting process of controlling the vehicle so that a vehicle speed of the vehicle becomes lower than a vehicle speed limit determined based on the evaluation value when the evaluation value is larger than the threshold value.

2. The remote driving system according to claim 1, wherein
the vehicle speed limit is determined so as to become lower as the evaluation value becomes larger.

3. The remote driving system according to claim 1, wherein
the evaluation value is calculated to be larger as a current vehicle speed is higher, and
the vehicle speed limit is determined such that an amount of decrease from the current vehicle speed to the vehicle speed limit becomes larger as the evaluation value becomes larger.

4. The remote driving system according to claim 1, wherein
the evaluation value includes a first evaluation value that reflects curvature of a road on which the vehicle travels,
the threshold value includes a first threshold value that is a threshold value of the first evaluation value, and
the vehicle speed limiting process includes a process of controlling the vehicle so that the vehicle speed of the vehicle becomes lower than the vehicle speed limit determined based on the first evaluation value when the first evaluation value is larger than the first threshold value.

5. The remote driving system according to claim 1, wherein
the evaluation value includes a second evaluation value that reflects gradient of a road on which the vehicle travels;
the threshold value includes a second threshold value that is a threshold value of the second evaluation value, and
the vehicle speed limiting process includes a process of controlling the vehicle so that the vehicle speed of the vehicle becomes lower than the vehicle speed limit determined based on the second evaluation value when the second evaluation value is larger than the second threshold value.

6. The remote driving system according to claim 1, wherein
when the vehicle speed limiting process is in execution, the one or more processors are further configured to execute a process of notifying the remote operator of a fact that the vehicle speed limiting process is in execution.

7. The remote driving system according to claim 1, wherein
the one or more processors are configured to refrain from executing the vehicle speed limiting process when the evaluation value is smaller than the threshold value.

8. The remote driving system according claim 1, wherein
the one or more processors are further configured to execute a process of smoothening a change in the vehicle speed when the vehicle speed limiting process starts and when the vehicle speed limiting process ends.

9. A control method for controlling a vehicle that is a target of remote driving by a remote operator,
the control method comprising:
determining whether or not an evaluation value, which indicates a degree of likelihood of an excessive operation by the remote operator and is calculated from a shape or a state of a road, is larger than a threshold value; and
controlling the vehicle so that a vehicle speed of the vehicle becomes lower than a vehicle speed limit determined based on the evaluation value when the evaluation value is larger than the threshold value.
